(19) United States
(12) Patent Application Publication
(10) Pub. No.: US 2014/0006107 A1
(43) Pub. Date: Jan. 2, 2014

(54) SYSTEM AND METHOD FOR DETERMINING PEDESTRIAN ORIGIN USING POINT OF SALE TRANSACTION DATA

(71) Applicant: Peter GROARKE, Dublin (IE)

(72) Inventor: Peter GROARKE, Dublin (IE)

(73) Assignee: MASTERCARD INTERNATIONAL INCORPORATED, Purchase, NY (US)

(21) Appl. No.: 13/538,226

(22) Filed: Jun. 29, 2012

(51) Int. Cl. G06Q 30/02

(52) U.S. Cl. 705/7.34

(57) ABSTRACT

A system (and a method) for determining origin of individuals engaging in point of sale payment card transactions, comprising an electronic storage device having a database of the payment card transactions stored therein; an access path for allowing access to information concerning the transactions, including when point of sale transactions have taken place, and a processor for assembling the information concerning point of sale transactions, to provide an indication of base currencies of the point of sale transactions in order to define the origin of the individuals. A computer readable non-transitory storage medium stores instructions of a computer program which when executed by a computer system, results in performance of steps of the method for determining origin of individuals engaging in point of sale payment card transactions.

### BACKGROUND OF THE DISCLOSURE

1. Field of the Disclosure

The present disclosure relates to payment card systems. More particularly, it relates to methods for exploiting the information generated by the transactions conducted on such systems.

2. Description of the Related Art

The first credit payment systems were two party systems in which a merchant sold goods to a customer without requiring full or any initial payment, but where the customer paid for the goods at a later date, or may have made periodic payments over a predetermined period of time. This method of payment is of limited scope and is not flexible, in that it involves only one merchant, and the customer must make individual arrangements with each and every merchant, and for each and every transaction.

In a three party system, a single card issuer contracts with customers and issues credit cards to them. The issuer also contracts with merchants, who agree to make sales to customers having a credit card from the issuer. When a card is presented at a merchant's establishment, it is generally the issuer who approves the transaction and pays the merchant. However, this system, a so-called closed system, has occasionally been modified so that another party approves the transaction and interacts with the merchant.

MasterCard, the assignee of the present application, operates within what is known as a “four-party” open payment card system. The four key participants in a four-party system are: (i) the consumer and business cardholders that use the cards; (ii) the merchants that accept the cards; (iii) the financial institutions that issue the cards (referred to as the card issuer); and (iv) the financial institutions that sign up merchants to accept the cards (referred to as the acquirer). In a typical four-party payment card transaction, the merchant pays a “merchant discount fee” (i.e., a merchant service charge) to the acquirer in recognition of the services provided by the acquirer in facilitating payment card acceptance by the merchant. However, a substantial portion of the benefits that the merchant receives through card acceptance comes from the value of the network and services performed by the card issuer. For example, the card issuer underwrites and extends credit to the cardholder of a credit card, which enables the sale, and the card issuer assumes the risk of nonpayment by the cardholder, which enables the merchant to get paid for the transaction even if card issuer does not. To compensate the card issuer for providing such benefits to the acquirer's merchant customer, the acquirer pays an “interchange fee” to the card issuer in connection with a payment card transaction. The interchange fee helps to partially reimburse the card issuer for the many activities it performs and costs it incurs that enable the acquirer to provide significant benefits and value to its merchant customers. Interchange fees are only one of the many cost components of the merchant discount fees that are established by acquirers and paid by merchants in exchange for card acceptance services provided by acquirers to merchants.

In general, the transaction system and associated methods described above work. However there are situations in which additional convenience for the participating merchants and the user would be desirable.

### SUMMARY OF THE DISCLOSURE

An embodiment of the invention is directed to a method (and a system) for determining the origin of individuals engaging in point of sale payment card transactions, comprising storing in an electronic storage device a database of the payment card transactions; accessing information in the database concerning the transactions, and assembling the information to provide an indication of base currencies of the point of sale transactions in order to determine the origin of the individuals.

The access path can comprise a web site for making the data available to users of the web site. The access path can include an Internet connected device for connecting to the web site. The Internet-connected device can be a mobile telephone, a computer including a desktop, laptop or notebook computer, a tablet, a personal digital assistant and the like, or any device providing similar functions.

The Internet connected device can include a display screen for displaying information concerning merchant establishments at a location where payment cards having a particular base currency were used.

The processor sorts the information concerning the transactions by at least one of time, transaction type and the base currency of the payment card.

The data can be displayed as a table indicative of the base currency of the transaction, number of transactions using the base currency, and percentage of total transactions using the base currency, for a selected time period and for a selected region.

The data is filtered so that the information in the database does not contain cardholder information related to the transactions.

The disclosure is also directed to a computer readable non-transitory storage medium storing instructions of a computer program which when executed by a computer system results in performance of steps of the method described for determining origin of individuals engaging in point of sale payment card transactions.

### BRIEF DESCRIPTION OF THE DRAWINGS

FIG. 1 is a diagram of a four party payment card system.

FIG. 2 is a block diagram of a portion of a payment card system modified in accordance with one aspect of the present disclosure.

FIG. 3 is a flow chart representing the manner in which acquired data is filtered to preserve confidentiality.

FIG. 4 is a flow chart illustrating the manner in which the system in accordance with the present disclosure is used.

A component or a feature that is common to more than one drawing is indicated with the same reference number in each of the drawings.

### DESCRIPTION OF THE EMBODIMENT

Merchants in a given area of a city are interested in the characteristics of pedestrian footfall in their area. Knowing, for example, the origin of cardholders that pass by the merchant location can provide the merchant with a helpful way of targeting their offers. Point-of-sale transaction data cardholder base currency is an indicator of a cardholder's country of origin.

Merchant address information in a transaction may be incomplete, but can be combined with a database of merchant identifications and precise merchant location information, for example the full address and/or the GPS data. When point-of-sale transactions are partitioned by cardholder base currency and time and dates, and aggregated over all merchants in an area, the data can be used to determine the cardholder origin. The data can be displayed graphically, or in list form, as more fully described below.

Knowing the origin of the cardholders will enable a merchant or store owner to more effectively target advertising at particular times or locations, to a group of interest.

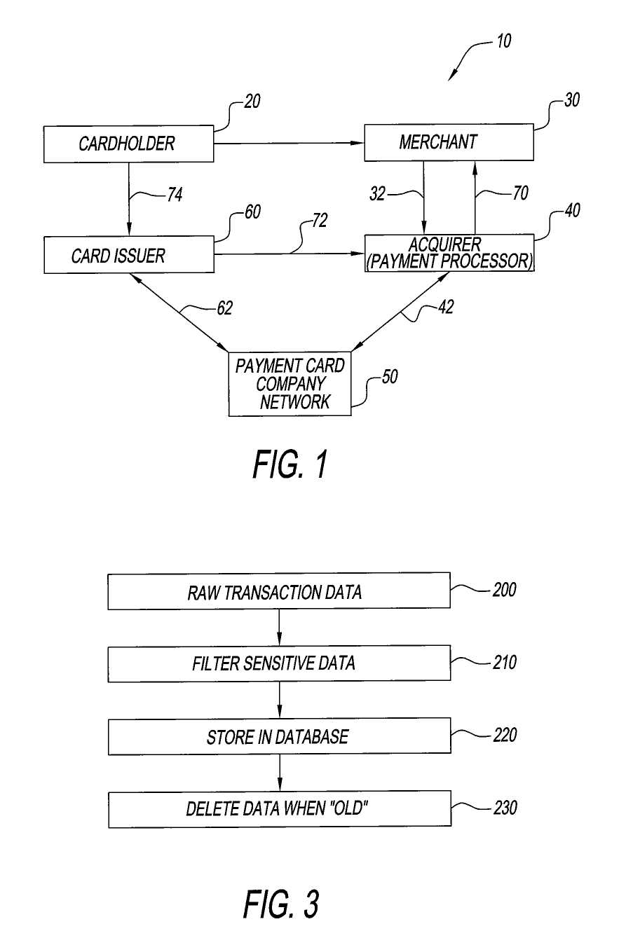

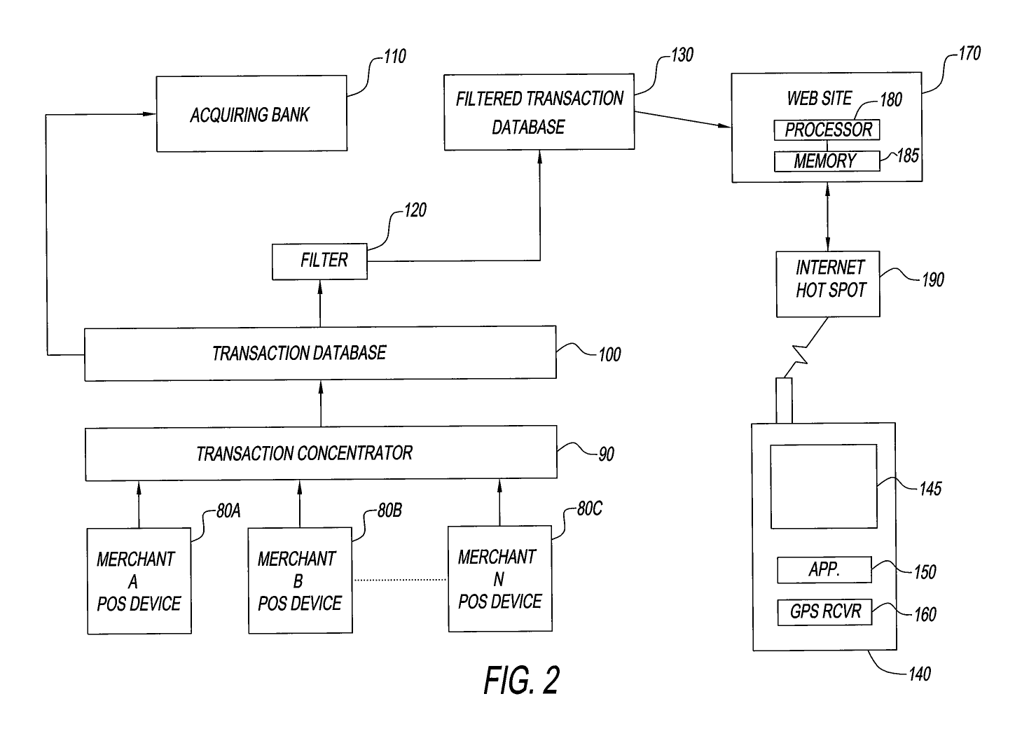

Referring to the drawings and, in particular, FIG. 1, there is shown a four party system 10. The cardholder 20 submits the payment card to the merchant 30. The merchant's point of sale device (80 in FIG. 2) communicates 32 with his acquiring bank or acquirer 40, which acts as a payment processor. The acquirer 40, at 42, initiates the transaction on the payment card network 50. The payment card network 50 routes the transaction to the issuing bank or card issuer 60, which is identified using information in the transaction message, more fully described below. The card issuer 60 approves or denies an authorization request. At 62, the card issuer 60, then routes, via the payment card network 50 an authorization response back to the acquirer 40. The acquirer 40 sends approval to the POS device of the merchant 30. Seconds later, the cardholder completes the purchase and receives a receipt.

The account of the merchant 40 is credited at 70 by the acquirer 40. The card issuer 60 pays the acquirer at 72. Eventually, at 74, the cardholder 20 pays the card issuer 60.

Referring to FIG. 2, each merchant has on their premises at least one card swiping machine or point of sale device 80, of a type well known in the art, for initiating customer transactions. These point of sale devices 80A, 80B, . . . 80N, generally also have keyboard data entry pads for entering data when a card's magnetic coding becomes difficult to read, or for the purpose of entering card data resulting from telephone calls during which the customer provides card data by telephone. Point of sale devices 80A, 80B, . . . 80N are connected by a suitable network to a transaction concentrator 90, for a given geographic area, which concentrates the transaction information. Each concentrator 90 has associated with it a transaction database 100 that stores information concerning the transaction. Information from the concentrator 90 is routed to a respective acquiring bank 110 that, in turn, routes the information so that transactions are properly completed using the system illustrated in FIG. 1.

While it is advantageous to maintain a local database including transactions in a given geographic area, there is no such limitation on various embodiments of the present disclosure. For example, if the present disclosure is used within a three party system, data for a relatively large geographic region may be stored in a single database at a central location. The time to search this more extensive database, and provide a response to a user, may be slightly greater, but the user will obtain the same useful information.

Information that is exchanged across the network for each credit or debit card financial transaction message includes the following characteristics: acquirer identifier/

Attorney card accepter identifier (the combination of which uniquely defines the merchant); merchant address (i.e., full address and or GPS data); merchant category code (also known as card acceptor business code), that is an indication of the type of business the merchant is involved in (for example, a gas station); local transaction date and time, cardholder base currency (i.e., U.S. Dollars, Euro, Yen, etc.), the transaction environment or method being used to conduct the transaction (as more fully explained below), product specific data such as SKU line item data, and cost of the transaction.

Transaction records stored in transaction database 100 contain information which is highly confidential and must be maintained as such to prevent fraud and identity theft. The transaction records stored in transaction database 100 are sent through a filter 120 (FIG. 3) that removes confidential information, but retains records concerning merchant identification and the occurrence of transactions at various times; preferably in real time. The filtered data is stored in a filtered transaction database 130 which may be accessed as described below. The data of the database may be stored in any type of memory, including a hard drive, a flash memory, on a CD, in a RAM, or any other suitable memory.

The following example of an approach to accessing the data involves a mobile telephone. However, it will be understood that that there are various other approaches, technologies and pathways that can be used. These include various types of alerts such as telephone calls, text messages, instant messages and e-mails. In most embodiments, it is not speed of response, but longer term trends that are of interest to the merchant. However, in those cases, as described below, where speed of response is important, a so called “push” technology should be used, where information is “pushed” out to the user, rather than waiting until the user decides to again check for messages. Any of these technologies can be used to provide locations, or in some cases a map of locations, where customers from a given geographic location, as represented by what base currency they are using, are present.

A mobile telephone 140, having a display 145, may have a series of applications or applets thereon including an applet or application program (hereinafter an application) 150 for use with the embodiments described herein. Mobile telephone 140 may also be equipped with a GPS receiver 160 so that its position is always known. Alternatively, if no GPS receiver is provided, application 150 may have provisions for entering the current location of the mobile telephone 140, such as for example the name of the town, and the streets forming an intersection where the mobile telephone 140 is located. As yet another alternative, the location of the merchant establishment may be entered, and can serve as a default location for future use by the merchant.

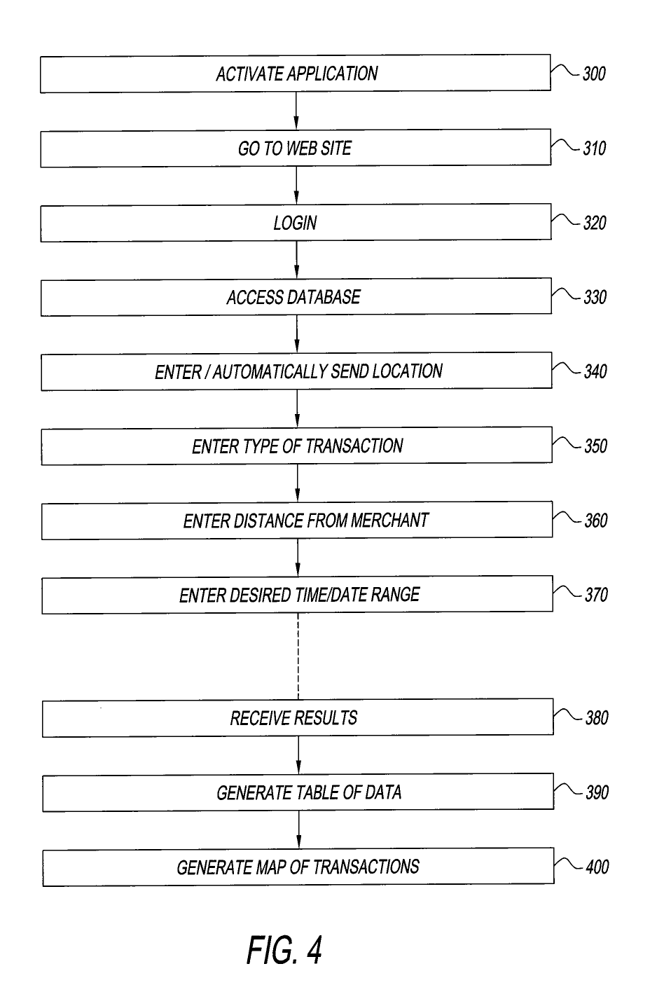

Mobile telephone 140 may be used to access a website 170 on the Internet, via an Internet connected Wi-Fi hot spot 190 (or by any telephone network, such as a 3G or 4G system, on which mobile telephone 140 communicates), by using application 150. Website 170 is linked to database 130 so that authorized users of website 170 may have access to the data contained therein. The manner in which that access is exploited, in accordance with the present disclosure, is described with respect to FIG. 4.

Web site 170 has a processor 180 for assembling data from filtered transaction database 130 for responding to merchant inquiries, as more fully discussed below with respect to FIG. 4. A memory 185 associated with web site 170, having a non-transitory computer readable medium, stores computer readable instructions for use by processor 180 in implementing the operation of the disclosed embodiment.

The system and method described herein can be used with a mobile device, because, in general, it may advantageously serve merchant representatives who are away from a home or business location, but would like to receive this information wherever they are in order to make business decisions quickly However, it will be understood that web site 170 may be accessed from a home or business computer, from a personal digital assistant, or any other Internet connected device, such as a tablet (for example, a device such as an iPad®).

Referring to FIG. 3, the operation of filter 120 (FIG. 2) is illustrated. The raw transaction data usually exchanged over the network is acquired at 200. At 210, customer sensitive information such as the credit card number and expiration date and other customer sensitive information is removed. At 220, the remaining data is stored in database 130 (FIG. 2). At 230, after a time, data which is no longer current or has become “old” or dated, and is no longer needed, in the context of the present embodiment, can be removed from the database. This serves to conserve space in the memory associated with database 130.

FIG. 4 illustrates the manner in which the present method or system is used by a merchant or user. At 300, the user activates application 150 on mobile telephone 140 (FIG. 2). Assuming that Internet access is available, at 310, optionally, the user will be directed to a log-in page of website 170 (FIG. 2). At 320, the user logs in with a user identification and password in a conventional manner, well known in the art. At 330, access is granted to the information in database 130

The manner in which the owner of web site 170 exploits the present method and system can vary. The web site may be available free to the public. Alternatively, a user fee may be charged, on a time of use, or periodic basis (such as monthly). Web site 170 may be made available only to merchants who accept cards from cardholders of the type of card being used to make those transactions, or only for free to such merchants. There are other possibilities for providing access to the web site.

At 340, information which is relevant to the location specified by the coordinates obtained from the GPS receiver 160 in mobile telephone 140, the entered location information, a predefined default location, or some other method of determining location, whether now know or later developed, can be sent from the mobile telephone 140 to the web site 170.

At 350, using mobile telephone 140, the user can enter a type of transaction to use as a filter on the data to be supplied from filtered transaction database 130. For example, a jewelry merchant may wish to limit the data to transactions involving jewelry, which may be accomplished by using merchant category codes as a filter. This allows targeting specific customers who have purchased similar items to those being sold by the merchant. However, in most cases, the merchant may wish to target a broader range of people. If no transaction type is designated at 350, then all transactions are considered.

At 360, it is possible to make an entry via mobile telephone 140 that filters transactions by a desired distance or radius from a particular location, such as from the GPS determined or entered location. The extent of the area or region where the data originated, based on the locations of the point of sale transactions producing the data, can be selected. For example, it is possible for a merchant, who does not keep detailed records, to use only his own payment card transaction data, by entering a distance of zero. Alternatively this may be broadened to include purchases by a group of merchants in a given location, such as for example all merchants in a given mall. On a broader basis, transaction data from all merchants in a given neighborhood or within a particular geographic radius may be aggregated for analysis. As an example, transaction date for merchants within a ten block radius of a particular location in midtown or lower Manhattan may be selected.

At 370, the user can enter a desired time or date range over which data is selected for analysis. For very local targeted advertising, this can be done for several hours or over the course of a day. For example, the arrival of a tourist bus in the area may indicate the immediate presence of tourists from South Korea, based on the base currency for very recent point-of-sale transactions. However, for more long-term advertising commitments, data can be taken over the course of a week, a month, a year or even several years to determine the long-term reliability of the data and whether data patterns are prone to reoccurrence over time. The data may also be sorted in different ways, for example, by time of day, by day of the week, particular weeks of the year, or by season. All of this information can be used to target marketing efforts, such as when and where to advertise, and even when a merchant establishment should be open.

At 380, the user will receive the results of a query in database 130 specific to any or all of the selected transaction type, distance from merchant, and the time/date range. As noted above, this information may be “pushed” out to the potential customer, and may not arrive for some time. Or it may be pulled, upon user demand. The lack of a hard connection, as shown by a dashed line between 370 and 380, is representative of a potential time delay. However, in some cases, the data may be available almost immediately.

At 390, the data may be displayed, regardless of the time frame and region selected, as a table with a list of countries representing the base currencies used by the cardholders, the actual number of sales in each of these base currencies, and the percentage of all sales taking place in each of the listed base currencies. Alternatively, the base currencies used in the point of sale transactions, and the language or languages that the persons engaging in the transactions would be likely to understand, can be listed, along with the actual number of sales in each of these base currencies, and the percentage of all sales taking place in each of the listed base currencies.

Alternatively, or as an additional function of application 150, on mobile telephone 140, or on a computer, a map may be generated, at 400, with, for example, dots of various colors indicating the locations of areas having a large number of point of sale transactions in each of the four or five base currencies having the highest number of sales, with a legend indicating what color is representative of each of the currencies. Application 150 may be configured so that if one of these locations on a map is selected by, for example, using a cursor, the exact names and addresses for local business establishments in that area is provided. The data used to make the map can be based on the desired time frame selected at 370.

### EXAMPLES

A diamond store owner in lower Manhattan is wondering how she can increase sales to foreign cardholders. Aggregated point-of-sale transaction data for lower Manhattan is broken down by cardholder base currency. The diamond store owner notices that there is a significant increase in the volume of transactions in the Saudi Riyal currency that occurs every Saturday morning in the area. She decides to open early on a Saturday and to advertise in Arabic. This provides targeted advertising for the merchant and informs the potential customers of the availability of the merchant to provide specific goods.

Alternatively the merchant may notice that there is an increase in volume of Japanese Yen spent on weekdays. She targets her advertising accordingly by advertising on inbound Japanese flights, and in key areas of the local international airport in Japanese. The merchant may also arrange for the distribution of coupons on the flights or in those areas of the airport through which the visitors may be likely to pass.

Thus, it is clear that the embodiments described herein benefit customers, as they are proactively given timely advertising information concerning merchant availability in a specific location. The system benefits retailers because potential customers are proactively informed of the availability of merchant establishments offering particular goods and services, and may be informed in a language they can understand based on the currency they are using. Retailers can use their advertising dollars most efficiently by properly targeting particular groups in accordance with the base currency that their payment cards utilize. Merchants are also assisted in making judgments as to when they should be open for possible sales activity.

In general, real-time data will not be required in various embodiments. However, if local advertising, such as displays within a mall that may be change on a regular basis, are available, then shorter-term data, sometimes approaching data acquired in real-time, can be more useful, in terms of providing targeted advertising, in the language of the country utilizing the base currency of the cardholders producing the point of sale transactions.

There are other diverse applications. For example, if a payment cardholder has access to the technology on a mobile telephone, and he becomes separated from the tourist group with which he is traveling, while at a mall or other crowded location, data can be analyzed to inform the cardholder of which merchant establishments in the mall are currently conducting transactions with other individuals using the same payment card base currency. Going to such a merchant location can result in the cardholder meeting up with members of his group, or at a minimum meeting up with someone who is likely to speak the same language, thus facilitating communication necessary to rejoin the group. Further, a very astute merchant, having at his establishment an individual who has been separated from his group, may use the merchant's mobile telephone or office computer to assist the individual in rejoining his tourist group, by using the application on a real-time basis. This establishes good will, and may result in additional sales.

It will be understood that while the present invention has been described primarily with respect to the four party system, it can also be applied, as noted above, to a three party system. Further, with suitable modifications, as will be understood by one skilled in the art, it can be applied to other kinds of payment card systems, such as debit or prepaid cards.

While most of the discussion above applies to credit card transactions, generally the same networks that are used to process credit card transactions also can be used to process debit cards and prepaid or preloaded payment cards. Point of sale devices such as those of FIG. 1, as well as gasoline pumps, and other places where a product may be sold, are equipped with input devices, such as push buttons or touch sensitive regions, which are used to indicate whether a payment card is a credit card or a debit card, or in some cases, some other type of payment card. While the legal rules for these different types of payments vary, they are processed in very similar ways at the point of sale.

One significant way in which debit cards depart from credit cards is the processing required to settle a transaction. While transaction concentrators can be used, the acquiring bank receives payment directly from the account of a cardholder, usually at another bank. Generally all of the funds required for the transaction must be on deposit in the account tied to the debit card, before the transaction will be approved. However, some banks have permitted transactions to be conducted involving more funds than are on deposit.

Settlement is similar for prepaid or preloaded cards. An account is established at a financial institution containing a predetermined amount of funds. When the card is presented for payment, funds are withdrawn from the account in an amount sufficient to cover the transaction. Purchases wherein an attempt is made to use more money than is in the account will not be approved.

In all of these cases, the record of transaction contains virtually the same information as discussed above. Thus, the operation of the disclosed embodiment may be essentially identical to what is disclosed with respect to FIG. 2.

It will be understood that the invention may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof

1. A system for determining origin of individuals engaging in point of sale payment card transactions, comprising:
an electronic storage device having a database of the payment card transactions stored therein;
an access path for allowing access to information concerning the transactions, including when point of sale transactions have taken place, and
a processor for assembling the information concerning point of sale transactions engaged in by pedestrians within a specified distance from a specified location, to provide an indication of base currencies of the point of sale transactions within the specified distance in order to determine the origin of said individuals who have engaged in the transactions.

2. The system of claim 1, wherein the database has data concerning transactions in a given geographic region.

3. The system of claim 1, wherein the data is filtered to remove cardholder information related to the transactions.

4. The system of claim 1, wherein the access path comprises a web site for making the data available to users of said web site.

5. The system of claim 4, wherein the access path includes an Internet connected device for connecting to said web site.

6. The system of claim 5, wherein said Internet connected device is one selected from the group consisting of a mobile telephone, a computer, a tablet and a personal digital assistant.

7. The system of claim 5, wherein said Internet connected device includes at least one of a GPS receiver and a location input screen for specifying location of said Internet connected device.

8. The system of claim 5, wherein said Internet connected device includes a display screen for displaying information concerning merchant establishments at a location where payment cards having a particular base currency were used.

9. The system of claim 1, wherein the processor also sorts the information concerning the transactions by at least one of time, transaction type and the base currency of the payment card.

10. The system of claim 1, wherein the data is displayed as a table indicative of the base currency of the transaction, number of transactions using the base currency, and percentage of total transactions using the base currency, for a selected time period and for the selected distance.

11. The system of claim 1, configured to process at least one of a credit card, a debit card, and a prepaid payment card transaction.

12. A method for determining origin of individuals engaging in point of sale payment card transactions, comprising:
storing in an electronic storage device a database of the payment card transactions;
accessing information in the database concerning the transactions, and
using a processor to assemble the information to provide an indication of base currencies of the point of sale transactions engaged in by pedestrians within a specified distance from a specified location in order to determine the origin of said individuals who have engaged in the transactions within the specified distance.

13. The method of claim 12, wherein the database has data concerning transactions in a given geographic region.

14. The method of claim 12, further comprising filtering the data to remove cardholder information related to the transactions.

15. The method of claim 12, wherein said accessing comprises using a web site for making the data available to users of said web site.

16. The method of claim 15, wherein said accessing comprises using an Internet connected device for connecting to said web site.

17. The method of claim 16, wherein said Internet connected device that is used is one selected from the group consisting of a mobile telephone, a computer, a tablet and a personal digital assistant.

18. The method of claim 16, further comprising using, in said Internet connected device, at least one of a GPS receiver and a location input screen, for providing location of said Internet connected device.

19. The method of claim 16, further comprising displaying on a display screen of said Internet connected device information concerning merchant establishments at a location where payment cards having a particular base currency were used.

20. The method of claim 12, further comprising sorting the information concerning the transactions by at least one of time, transaction type and the base currency of the payment card.

21. The method of claim 12, further comprising displaying as a table data indicative of the base currencies of the transactions, number of transactions using a base currency, and percentage of total transactions using a base currency, for a selected time period and for the selected distance.

22. The method of claim 12, wherein the payment card transactions are performed by using credit cards, debit cards, and prepaid cards.

23. A computer readable non-transitory storage medium storing instructions of a computer program which when executed by a computer system results in performance of steps of a method for determining origin of individuals engaging in point of sale payment card transactions, comprising:
storing in an electronic storage device a database of the payment card transactions;
accessing information in the database concerning the transactions, and assembling the information to provide an indication of base currencies of the point of sale transactions engaged in by pedestrians within a specified distance from a specified location in order to define the origin of said individuals who have engaged in the transaction within the specified distance.

24. The method of claim 12, wherein the specified location is the location of the merchant.

25. The method of claim 12, further comprising using information concerning origin of the pedestrians to selectively target advertising of the merchant.

26. The system of claim 1, wherein the distance is selected from the group of zero distance, within a same mall as the merchant, within a selected number of blocks of the merchant, and within the neighborhood of the merchant.
